(19) United States
(12) Patent Application Publication
(10) Pub. No.: US 2025/0081897 A1
(43) Pub. Date: Mar. 13, 2025

(54) AUTOMATED INDOOR GROWING APPARATUSES AND RELATED METHODS

(71) Applicant: 80 ACRES URBAN AGRICULTURE INC., Hamilton, OH (US)

(72) Inventors: Kees Breukel, CG Delft (NL); Marta Kowalczuk, CG Delft (NL); Steve Brudnicki, Hamilton, OH (US); Anthony Nocito, Hamilton, OH (US); Robert Schouten, CG Delft (NL); Jules Vitters, CG Delft (NL); Nick Soeteman, CG Delft (NL)

(21) Appl. No.: 18/882,146

(22) Filed: Sep. 11, 2024

Related U.S. Application Data
(60) Provisional application No. 63/582,206, filed on Sep. 12, 2023.

(51) Int. Cl. A01G 9/24; B01D 24/48; B01D 33/06; B01D 33/48; B01D 33/80; B01D 36/02; C02F 1/00; C02F 1/78; F24F 13/02

(52) U.S. Cl. CPC A01G 9/246; A01G 9/247; B01D 24/4861; B01D 33/06; B01D 33/48; B01D 33/807; B01D 36/02; C02F 1/004; C02F 1/78; F24F 13/0236; B01D 2201/202; C02F 2301/046; C02F 2303/04

(57) ABSTRACT

An indoor growing facility includes a grow zone configured for growing crops and an air handling apparatus comprising a supply plenum wall at one end of the grow zone, and a return plenum wall at an opposite end of the grow zone. The return plenum wall may include intake openings that vary in size to create variable suction. The indoor growing facility may also include an irrigation system that includes an irrigation skid coupled to a supply tank, fertigation apparatus, and the grow zone. The indoor growing facility may also include a filtration system comprising an ozone apparatus, a regenerative filter apparatus, and a drum filter apparatus.

### CROSS-REFERENCE TO RELATED APPLICATIONS

This application claims priority to and the benefit of U.S. Provisional Patent Application No. 63/582,206 filed on Sep. 12, 2023, the contents of the above application is incorporated by reference herein in its entirety.

### FIELD

The present disclosure relates to automated indoor growing facilities, apparatuses and related methods.

### BACKGROUND

This section provides background information related to the present disclosure which is not necessarily prior art.

Global food production systems need to address significant challenges in the coming decades. Finding ways to feed a growing global population whilst reducing environmental impact of agricultural activities is of critical importance. Controlled environment agriculture (CEA), which includes greenhouses and indoor farming, offers a realistic alternative to conventional production for some crops. Indoor farming allows for faster, more controlled production, irrespective of season, with more efficient use of resources. Further, indoor farming is not vulnerable to other environmental variability such as pests, pollution, heavy metals, and pathogens. Indoor farming can also reduce environmental impact by offering reduced land requirements, better control of waste, less production loss, reduced transportation cost, and reduced clean water usage. Therefore, indoor farming can help to address the significant challenges.

Current methods and systems for indoor farming, however, are relatively expensive to implement and do not efficiently utilize the available space within a room or enclosure for growing crops. Furthermore, existing indoor farming facilities suffer from inefficiencies and inconsistencies in the inputs to the growing chambers. There exists a need, therefore, for improved indoor growing facilities to improve these drawbacks.

### SUMMARY

This section provides a general summary of the disclosure, and is not a comprehensive disclosure of its full scope or all of its features.

The present disclosure provides apparatuses and methods for the indoor growing and automated growing of plants and crops. The apparatuses and methods of the present disclosure provide improvements in efficiency, yield, and cost over existing or traditional methods and apparatuses. The apparatuses and methods of the present disclosure may result in less resources that are required to yield mature plants and require less space, land, manpower while providing improved traceability, transparency and sustainability over existing or traditional apparatuses and methods.

The apparatuses and methods of the present disclosure may provide an indoor facility that include improvements over known or existing facilities. In some embodiments an improved indoor growing facility is provided. The indoor growing facility may include a grow zone configured for growing crops and an air handling apparatus comprising a supply plenum wall at one end of the grow zone, and a return supply plenum wall at an opposite end of the grow zone. The return supply plenum wall may include intake openings that vary in size to create variable suction. The indoor growing facility may also include an irrigation system that includes an irrigation skid coupled to a supply tank, a fertigation apparatus, and the grow zone. The indoor growing facility may also include a filtration system comprising an ozone apparatus, a regenerative filter apparatus, and a drum filter apparatus.

### DRAWINGS

The drawings described herein are for illustrative purposes only of selected embodiments and not all possible implementations, and are not intended to limit the scope of the present disclosure.

FIG. 1 is a side view of an example indoor growing facility in accordance with some embodiments of the present disclosure.

FIG. 2 is an isometric illustration of an example air handling system that may be used in an indoor growing facility of the present disclosure.

FIG. 3 is a magnified view of the example supply plenum wall shown in FIG. 2.

FIG. 4 is another view of the example supply plenum wall of FIG. 2.

FIG. 5 is a side view showing further aspects of the air handling system and supply plenum wall of FIG. 2.

FIG. 6 is an image of an example distributor that may form part of a supply plenum wall of the present disclosure.

FIG. 7 is another image of the example distributor of FIG. 6.

FIG. 8 is an isometric view of example intake boxes that may form all or part of a return plenum wall of the present disclosure.

FIG. 9 is another view of the example intake boxes of FIG. 8.

FIG. 10 is a view of an example return plenum wall that may be included in the air handling system of FIG. 2.

FIG. 11 is a back view of the return plenum wall of FIG. 10.

FIG. 12 is a side view of the return plenum wall of FIG. 10.

FIG. 13 is a magnified view of the flow guide shown in FIG. 12.

FIG. 14 is a block diagram illustrating an example irrigation system in accordance with some embodiments of the present disclosure.

FIG. 15 is a block diagram illustrating another example irrigation system in accordance with some embodiments of the present disclosure.

FIG. 16 is a block diagram illustrating another example irrigation system in accordance with some embodiments of the present disclosure.

FIG. 17 is block diagram illustrating another example irrigation system in accordance with some embodiments of the present disclosure.

FIG. 18 is a block diagram illustrating another example irrigation system in accordance with some embodiments of the present disclosure.

FIG. 19 is a schematic diagram illustrating an example pump skid in accordance with some embodiments of the present disclosure.

FIG. 20 is a magnified portion of the schematic diagram of FIG. 19.

FIG. 21 is another magnified portion of the schematic diagram of FIG. 19.

FIG. 22 is a top view of an example pump skid in accordance with some embodiments of the present disclosure.

FIG. 23 is a side view of the example pump skid of FIG. 22.

FIG. 24 is a front view of the example pump skid of FIG. 22.

FIG. 25 is a diagram illustrating an example filtration system in accordance with some embodiments of the present disclosure.

FIG. 26 is a diagram illustrating an example air handling system in accordance with some embodiments of the present disclosure.

FIG. 27 is a schematic diagram illustrating an example fluid control system for providing hot and cold water to an air handling system in accordance with some embodiments of the present disclosure.

FIG. 28 is magnified portion of the schematic diagram of FIG. 27.

FIG. 29 is another magnified portion of the schematic diagram of FIG. 27.

FIG. 30 is an image of an example irrigation system in accordance with some embodiments of the present disclosure.

FIG. 31 is an image of an example irrigation skid in accordance with some embodiments of the present disclosure.

FIG. 32 is an image of an example supply skid in accordance with some embodiments of the present disclosure.

FIG. 33 is an image of an example EC/pH sensor skid in accordance with some embodiments of the present disclosure.

FIG. 34 is an image of an example ozone filter system in accordance with some embodiments of the present disclosure.

Corresponding reference numerals indicate corresponding parts throughout the several views of the drawings.

### DETAILED DESCRIPTION

Example embodiments will now be described more fully with reference to the accompanying drawings. For purposes of the description hereinafter, it is to be understood that the embodiments described below may assume alternative variations and embodiments. It is also to be understood that the specific articles, compositions, and/or processes described herein are exemplary and should not be considered as limiting. In the description, relative terms such as “lower,” “upper,” “horizontal,” “vertical,”, “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

In the present disclosure the singular forms “a,” “an,” and “the” include the plural reference, and reference to a particular numerical value includes at least that particular value, unless the context clearly indicates otherwise. When values are expressed as approximations, by use of the antecedent “about,” it will be understood that the particular value forms another embodiment. As used herein, “about X” (where X is a numerical value) preferably refers to ±10% of the recited value, inclusive. For example, the phrase “about 8” preferably refers to a value of 7.2 to 8.8, inclusive. Where present, all ranges are inclusive and combinable. For example, when a range of “1 to 5” is recited, the recited range should be construed as including ranges “1 to 4”, “1 to 3”, “1-2”, “1-2 & 4-5”, “1-3 & 5”, “2-5”, and the like. In addition, when a list of alternatives is positively provided, such listing can be interpreted to mean that any of the alternatives may be excluded, e.g., by a negative limitation in the claims. For example, when a range of “1 to 5” is recited, the recited range may be construed as including situations whereby any of 1, 2, 3, 4, or 5 are negatively excluded; thus, a recitation of “1 to 5” may be construed as “1 and 3-5, but not 2”, or simply “wherein 2 is not included.” It is intended that any component, element, attribute, or step that is positively recited herein may be explicitly excluded in the claims, whether such components, elements, attributes, or steps are listed as alternatives or whether they are recited in isolation.

The present disclosure is directed to indoor growing facilities, growing apparatuses and related methods. The facilities, apparatuses and methods of the present disclosure are improvements over existing or traditional growing and farming equipment and processes. The disclosure below includes aspects of indoor growing facilities that may be used in various different indoor growing facilities. To assist in the description of the apparatuses and methods, one or more indoor growing facilities are discussed but it should be appreciated that the apparatuses, uses, and aspects thereof are not limited to the embodiments shown and discussed below.

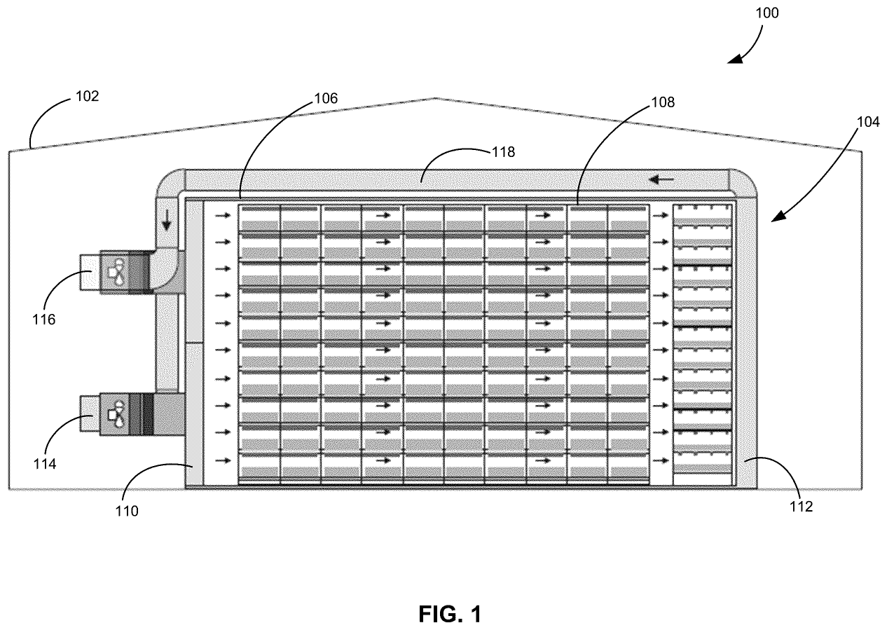

As shown in FIG. 1, an example indoor growing facility 100 is shown. The indoor growing facility 100 may include an outer building 102 and an inner growing chamber or grow zone 104. The grow zone 104 may be enclosed within the outer building 102 as shown. The grow zone 104 may include a growing shell 106 that may separate or isolate crops growing inside the grow zone 104 from the environment of the outer building 102. This isolation may allow a precisely and accurately controlled environment to be created inside the grow zone 104 for the crops. The crops may also be isolated from insects, bacteria, and/or other contaminants. The crops may be grown much faster and without pesticides, pollution, or other contaminants as compared to traditional farming methods.

The environment of the grow zone 104 may be controlled using one or more environmental systems that may be coupled to the grow zone. The environmental systems may include lighting systems, irrigation systems, air treatment and handling systems, fertilization systems, and others. The crops that are growing in the grow zone 104 are growing in multiple vertical layers and may be positioned on a rack, or other structure to allow trays, containers, or benches of crops to move among the vertical layers and along the structure from one end of the grow zone 104 to an opposite end of the grow zone 104. As the crops move through the grow zone, the crops may grow until ready for harvest when they are removed from the grow zone 104 and harvested from the growing benches and packaged for delivery to customers. The movement of the benches within indoor farming facility 100 may be automated. Other systems of the indoor farming facility 100 may also be automated so that the various environmental systems maintain a desired environment in the grow zone 104 to maximize growth of the crops and result in improved yield over traditional farming apparatuses and methods.

The indoor farming facility 100 may include an air handling system that causes a desired airflow to be maintained in the grow zone 104. In the example shown, the grow zone 104 may include a supply plenum wall 110 positioned at one end and a return supply plenum wall 112 positioned at an opposite end. One or more air handling units (AHU), such as AHU 114 and 116, may be coupled to the supply plenum wall 110 to provide a supply of conditioned air. The supply plenum wall 110 may be configured to distribute the conditioned air to the grow zone 104 to provide a desired quality of flow (e.g., laminar or turbulent flow), direction of flow, air velocity, volume, temperature, and humidity. The air flow with the desired flow characteristics and air properties may flow out of the supply plenum wall 110 over the crops positioned in the grow zone 104 and be received into the return plenum wall 112. The crops may be position on a multi-tiered structure 108. The structure 108 may include a multiple vertical and/or horizontal racks or supports to hold and move multiple benches, that include the growing crops, through the grow zone 104.

After flowing through the grow zone 104 and over the crops, the air flow may be received in the return plenum wall 112. The air flow may then move from the return plenum wall 112 back to the air handling units 114, 116 through return duct 118. The air may be re-conditioned before the air is returned to the grow zone 104 through the supply plenum wall 110. In this manner, a desired air flow can be maintained in the grow zone 104.

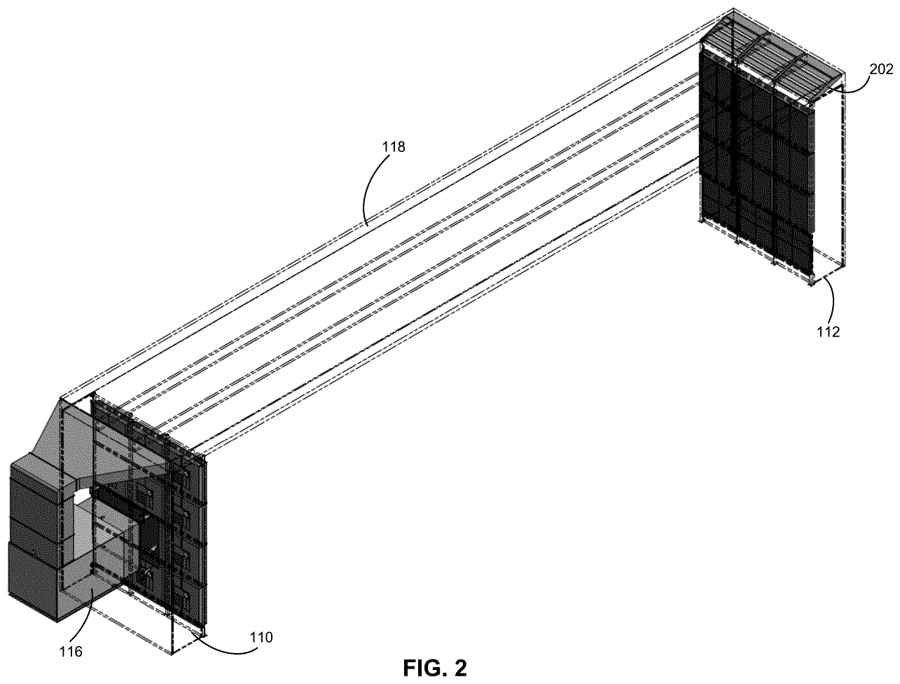

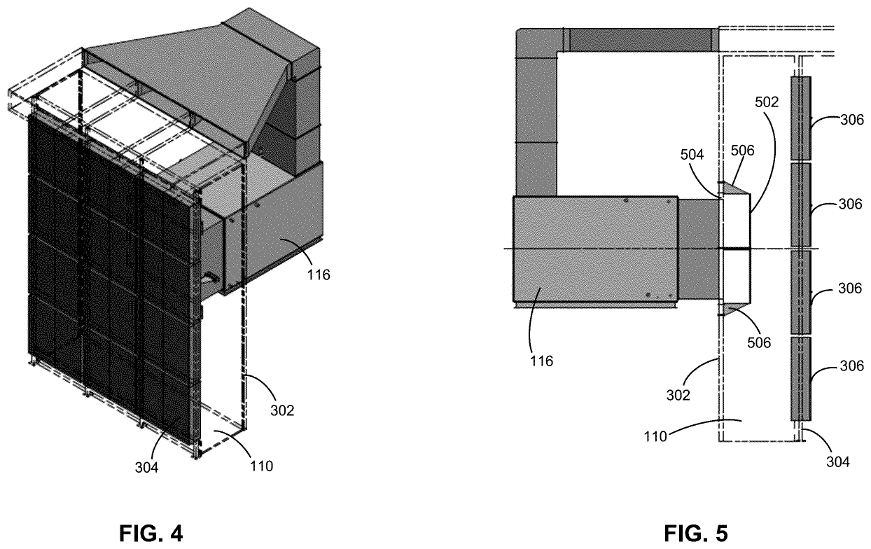

With reference to FIGS. 2-13, one embodiment of the supply plenum wall 110 and the return plenum wall 112 is shown. In some of the figures, aspects may be shown in dashed or phantom lines for illustration purposes. As shown in FIG. 2, the supply plenum wall 110 may be coupled to an air handling unit 116. In this example, only one supply plenum wall 110 and one return plenum wall 112 are shown spaced apart from one another with the air handling unit coupled to the supply plenum wall 110 at an outside wall of the supply plenum wall 110. It should be appreciated that some grow zones 104 may include more than one air handling unit that may be sized and rated to produce sufficient air flow for the size of the grow zone 104. In some alternate embodiments, the features shown in FIGS. 2-13 may be reproduced and positioned adjacent to one another to construct larger supply plenum walls 110 and larger return plenum walls 112 in order to serve larger sized grow zones 104.

The return plenum wall 112 may include or be coupled to a flow guide 202 that may be positioned at a top portion of the return plenum wall 112 and functionally couple the return plenum wall 112 to the return duct 118. The flow guide 202 may assist in directing air from a substantially vertical flow direction to a substantially horizontal flow direction. As will be further described, the flow guide 202 may include one or more vanes, louvres, or vents to help change the direction of the air flow without causing significant turbulence and/or back pressure in the flow path.

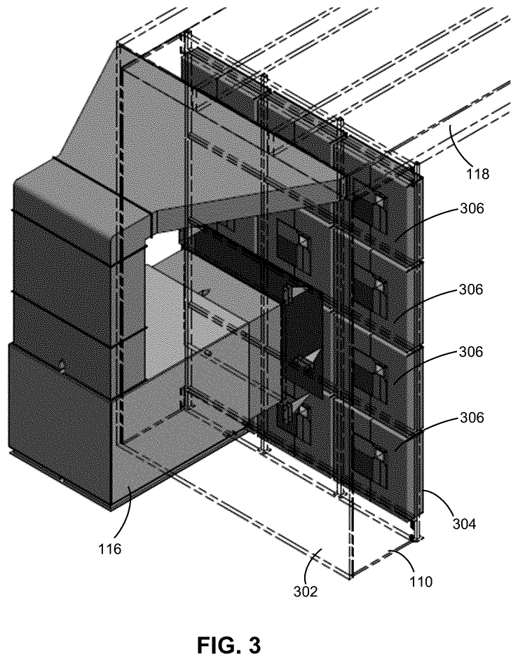

Referring now to FIG. 3, a portion of the air handling system is shown that includes the supply plenum wall 110 and the air handling unit 116. As shown, the supply plenum wall 110 may form a rectangular box with an outside wall 302 and an inside wall 304. The air handling unit 116 may be coupled to the outside wall 302 to supply conditioned air to the interior volume of the supply plenum box. The conditioned air may fill the supply plenum wall 110 and be distributed to the grow zone 104 through the inside wall 304. The air flow may be distributed through the supply plenum wall so that the air flow is distributed evenly to the grow zone such that the output from the inside wall 304 of the supply plenum wall 110 does not vary significantly across the width or across the height of the supply plenum wall 110. In some embodiments, it may be desired that the flow coming into the grow zone 104 via the inside wall 304 is laminar flow.

The outside wall 110 may include an opening 504 (FIG. 5) through which the supplied airflow from the air handling unit 116 may enter the interior of the supply plenum wall 110. A diverter 502 may be positioned inside the interior volume of the supply plenum wall 110 and be located at a positioned spaced apart from the outer wall 302. The diverter 502 may be secured to the outer wall 110 opposite to the opening 504. The diverter 502 may connected to the outer wall 302 by one or more supports 506. The diverter 502 may be made of a perforated or screen material or diffuser plate that may allow the airflow to flow through the diverter 502. The diverter 502, while allowing some airflow to pass through the perforations, deflects airflow in all directions perpendicular to the main direction of the airflow into the grow zone 104 such that the airflow fills the interior volume of the supply plenum wall 110. The diverter 502 spreads the airflow along the surface of the inner wall 304 without requiring additional duct work. Use of the additional ductwork has various drawbacks, including condensation issues that require insulation or other remedial measures. As can be appreciated, without diverter 502, the airflow would flow in a substantially straight direction from the opening 504 to a central portion of the inner wall 304. This type of airflow may be undesirable because the airflow properties (e.g., velocity and volume) would be greater at a center of the supply plenum wall as compared to the edges or boundary portions of the supply plenum wall 110. As can be appreciated, alternative embodiments may include a series of diffuser plates or diverters 502 positioned so as to deflect airflow in a desired pattern.

The inner wall 304 of the supply plenum wall 110 may be made of one or more distributors 306. The distributors 306 further spread the airflow and distribute the airflow evenly as it leaves the supply plenum wall 110. The distributors 306 may be arranged in an array to form the inner wall 304. In the example shown, the inner wall 304 is formed from a 3 by 4 array of rectangular-shaped distributors 306. In other examples, other sizes, arrays, and configurations may be used.

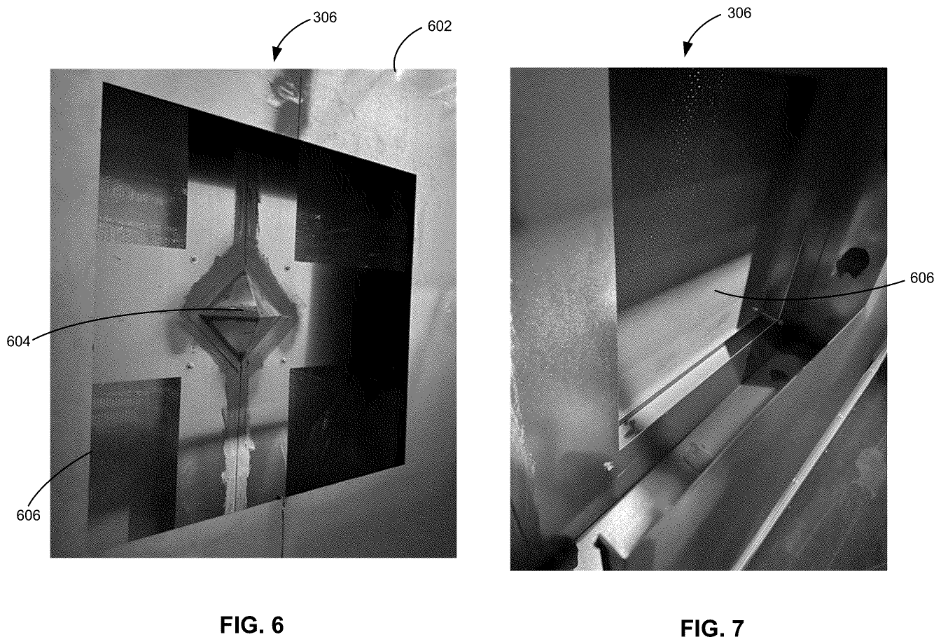

Each of the distributors 306 may form a rectangular or square-shaped box. As shown in FIGS. 6 and 7, the inward-facing side of the distributor may include a port 602 through which airflow may enter the distributor. The interior of each distributor 306 may include a projection 604 to guide the airflow away from the center of the distributor 306 toward the sides of the distributor. The projection 604, in the example shown, has a pyramid shape that is angled relative to the surface of the distributor 306. In other examples, the projection 604 may have other shapes, such as a cone or other angled surface. The airflow may then flow through one or more apertures 606. In this example, each distributor 306 includes four apertures located at or near the four corners of the distributor 306. In other examples, the apertures 606 may be sized or arranged differently to distribute the airflow. The downstream side of the apertures may include diffuser plates, be perforated, screened or otherwise formed to further distribute the airflow. The downstream side of the apertures 606 may form the inner face of inner wall 304 of the supply plenum wall 110.

One or more portions of the supply plenum wall 110 may be formed of various materials. In one example, the supply plenum wall 110 may be formed of insulated metal panels (IMP). Such panels may have an insulated foam core. Such insulation may improve efficiency in the system and prevent condensation from forming on the panels.

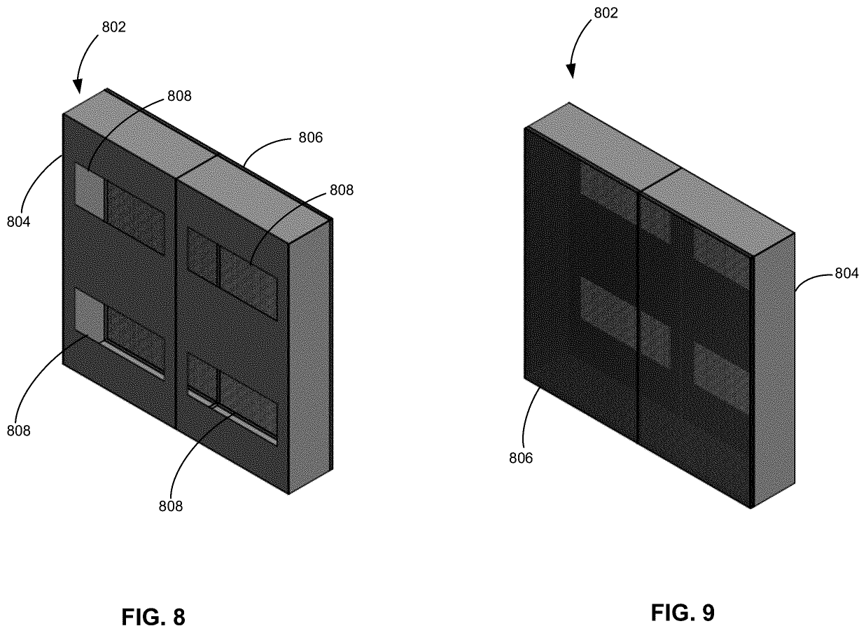

Referring now to FIGS. 8-13 further aspects of the return plenum wall 112 are shown. As previously described, the return plenum wall 112 may be positioned at an opposite side of the grow zone 104 than the supply plenum wall 110 and be configured to collect and return airflow to the air handling unit 116. As can be appreciated, the return plenum wall 112 may have a negative pressure relative to the supply plenum wall 110 and may cause the airflow to move in a horizontal fashion from the supply plenum wall 110 to the return plenum wall 112 in the grow zone 104.

It has been observed that there may be other factors that influence the airflow in the grow zone 104. Such other factors may include natural factors such as the density of the air. The natural density of cool air tends to cause cool air to move downward and less dense warm to move upwards. Such a chimney effect has been observed in grow zones 104. The transpiration of the crops, the heat from the lighting systems, humidity, the movement of the crops in the structure and other factors may disturb or cause variation in the airflow in the grow zone 104. The warmer air may move upwards and the cooler air may move downwards. Thus, the airflow in the grow zone may vary at different horizontal levels or heights within the grow zone 104.

It is desirable, however, to maintain a balanced and distributed airflow in the grow zone 104. To assist in achieving this goal, the suction or pressure differential at the return plenum wall 112 may be varied along a height of the return plenum wall 112. It may be desirable, for example, to have greater suction or pressure differential at lower sections than at higher sections of the grow zone 104 to counteract the natural tendency of upwards airflow as the airflow heats during its flow through the grow zone 104. This may be accomplished by having larger intake openings in the return plenum wall 112 at lower levels as compared to higher levels.

In one example, the return plenum wall 112 may be formed from intake boxes 802. The intake boxes 802 may form a rectangular box with an intake side 806 (i.e., the side facing the grow zone 104) that includes a diffuser plate, perforated material and/or screen. The airflow may then flow into the return plenum wall 112 through opposite side 804. The exit side 804 may include one or more intake openings 808. In this example, the intake openings 808 have a rectangular shape, however, other shapes may be used. The size of the intake openings 808 may be formed to achieve a desired suction or pressure differential at the return plenum wall 112. For example, intake boxes 802 that are positioned at the top of the return plenum wall 112 may have intake openings 808 of a size or area that is smaller than the size or area of intake openings 808 positioned at the bottom of the return plenum wall 112. The airflow may enter the intake boxes 802 from the intake side 806 and then flow out the opposite side 804 and to the return duct as will be further described below.

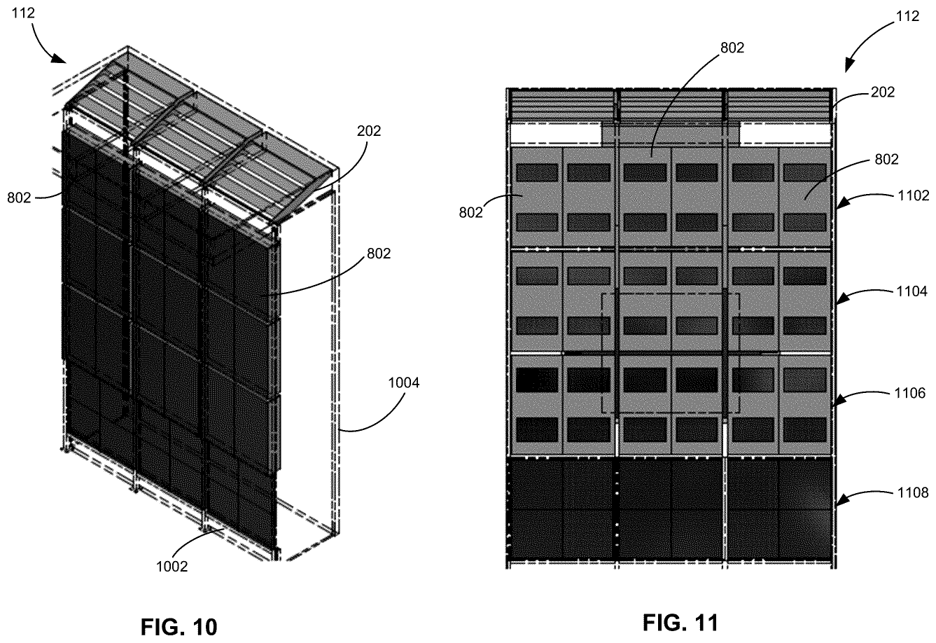

As shown in FIGS. 10 and 11, the return plenum wall 112 may be formed from an array of intake boxes 802. The array of intake boxes 802 may include rows of similarly sized and configured intake boxes 802. The size and configuration of each intake box in a particular row may be the same. In the example shown, the array includes a first row 1102, a second row 1104, a third row 1106, and a fourth row 1108. The size of the intake openings of the intake boxes in the first 1102 are the same. The size of the intake openings of the intake boxes in the second row 1104 are the same. The size of the intake openings in the intake boxes in the third row 1106 are the same. The size of the intake boxes in the fourth row 1108 are the same.

The size of the intake openings in the fourth row 1108 are greater than the size of the intake openings in the third row 1106, the second row 1104, and the first row 1102. Each row is sized to create greater suction or greater pressure differential than the row above it. In this manner, the natural tendency of an upwards airflow in the grow zone 104 can be counteracted by the sizing the openings in the intake boxes of the return plenum wall 112 using displacement ventilation. The openings in the intake boxes may be vertically positioned to correspond to a row in the structure that supports the rows of crops in the grow zone 104. This may further assist in achieving a constant and laminar flow of air over the crops in the grow zone 104. In one example, the fourth row 1108 includes a perforated screen that results in a fully open intake opening the size of the intake box 802, while third row 1106 includes intake openings that are approximately 37% of the surface are of the intake box 802, and the second and the first rows 1104 and 1102 have intake openings that are approximately 26% of the surface area of the respective intake box 802. In other examples, other relative sizing may be used.

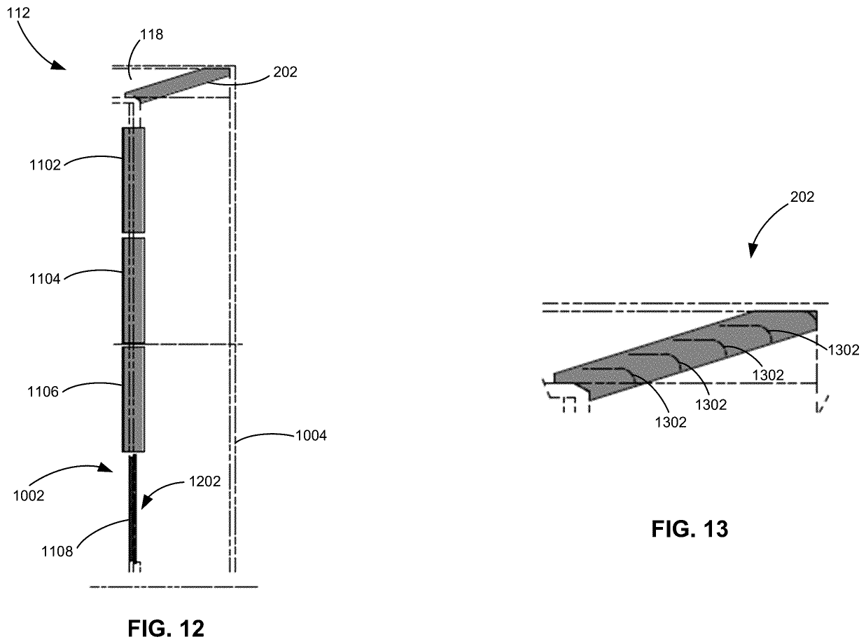

As shown in the example of FIG. 12, the lower-most row of intake boxes may be configured as a screened or perforated wall 1202. As shown, the fourth row 1108, in this example, is not configured as an intake box but may be formed of a layer of a diffuser plate, or screening or perforated material. In this manner, the size of the opening and the suction or pressure differential at the fourth row 1108 may be maximized at this lowest height in the return plenum wall 112. In other examples, the fourth row 1108 may be formed of intake boxes as previously described. Furthermore, the return plenum wall 112 may include more or less than four rows of intake boxes and may include a suitable number of rows as may be appropriate for the size of the grow zone 104.

As further shown in FIGS. 10 and 12, the return plenum wall 112 may form an interior space that allows the return airflow to flow from the grow zone upwards to the return duct 118 where it may return to the air handling unit 116 (see FIG. 2). The return plenum wall 112 may include an inner side 1002 formed of the intake boxes as previously described. The return plenum wall 112 may also include an outer side 1004 spaced apart from the inner wall 1002. One or more portions of the return plenum wall may be formed of insulated metal panels with an insulated core to improve efficiency and reduce condensation.

At a top portion of the return plenum wall 112, the return plenum wall 112 joins the return duct 118. At this location, the return plenum wall 112 may include the flow guide 202. The flow guide 202 may be positioned at the connection of the return plenum wall 112 to the return duct 118 to reduce pressure loss in the return flow path. In the example shown, the flow guide 202 may include one or more vanes 1302 positioned at this corner location. The vanes 1302 may be curved members configured to guide airflow around the corner from the return plenum wall 112 to the return duct 118. The vanes 1302 may be rigid members spaced apart from each other. The vanes 1302 may be secured diagonally across the corner of the return plenum wall 112 and return duct 118 intersection. In other examples, other configurations of the flow guide 202 may be used such as other louvres, ports, fins, or the like.

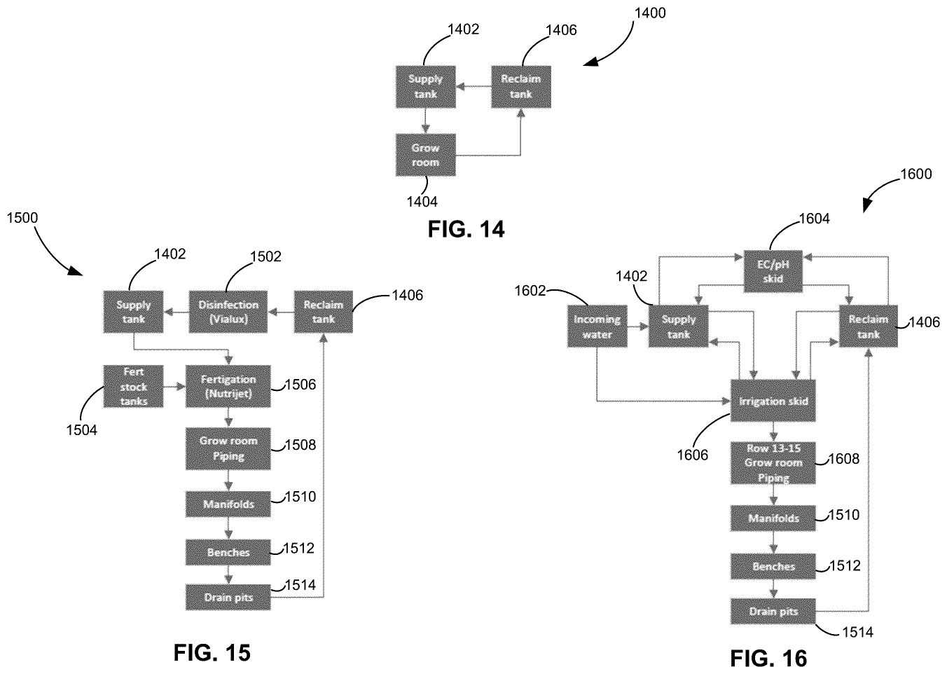

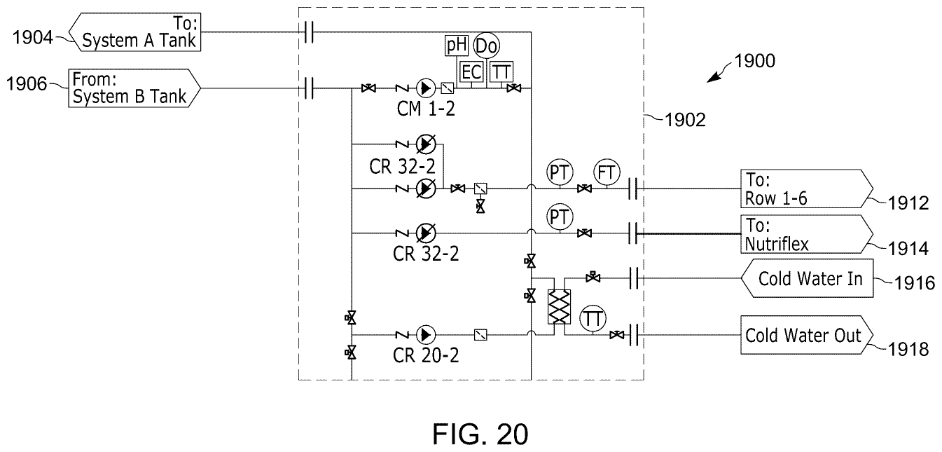

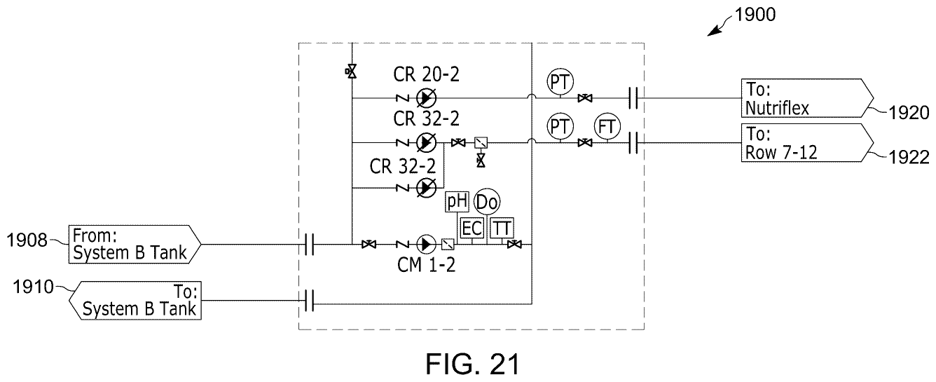

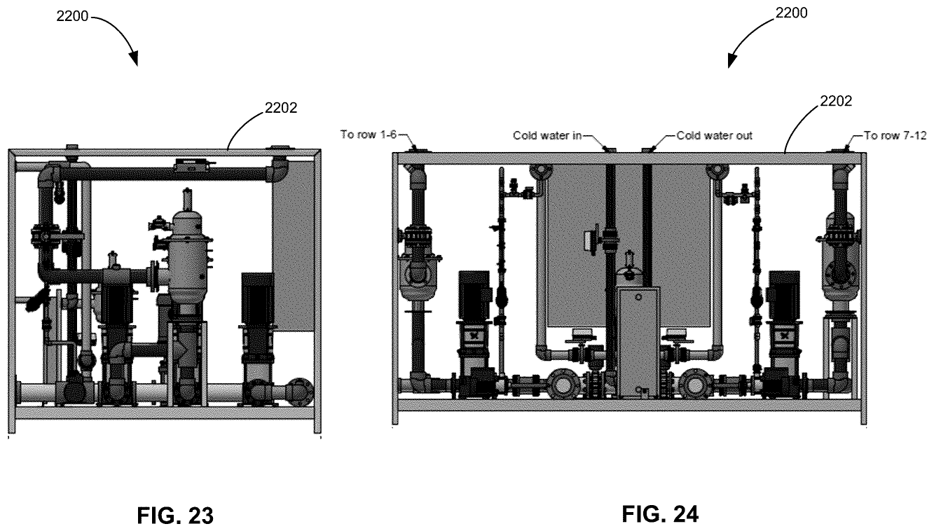

Referring now to FIGS. 14-24, various embodiments and aspects of irrigation systems are shown. The irrigation systems may provide water and/or nutrients to the crops growing in the grow zone 104. The irrigation systems may prepare, hold, and supply the water and/or nutrients for the crops.

The embodiment shown in FIG. 14 illustrates example irrigation system 1400. The irrigation system 1400 may include a supply tank 1402 and a reclaim tank 1406. The supply tank 1402 may supply water and/or nutrients to the grow room 1404. The grow room 1404 may be configured as the grow zone 104 previously described. In other examples, the grow room 1404 may have other configurations.

FIG. 15 illustrates an example irrigation system 1500. The irrigation system 1500 may include a supply tank 1402 and a reclaim tank 1406. The supply tank 1402 may hold a volume of water for supply to the grow room. The reclaim tank 1406 may hold a volume of water or other liquid mixture that is collected, captures, or recycled from the grow room. The grow room may be configured to hold a plurality of benches in which the crops are grown. The benches and/or trays in which the crops are grown may have the configuration and structure described in U.S. patent application Ser. No. 18/048,086 filed on Oct. 20, 2022 entitled AUTOMATED INDOOR GROWING APPARATUSES AND RELATED METHODS, contents of which are incorporated by reference in its entirety herein. The benches may be configured to hold a tray or other receptacle in which growing medium and the crops are positioned. The benches may be flooded with water and/or other liquid mixture to provide water and nutrients to the crops. The water and/or other liquid mixture may be drained from the benches since not all liquid provided or flooded into the benches will be absorbed by the crops. This liquid that is drained from the benches may be moved to the reclaim tank 1406. Additionally, moisture created by the transpiration of the plants within the grow zone 104 may be collected as the air from the grow zone 104 is cooled and condensate is collected. This collected condensate from the humid air from the grow zone 104 may also be added to the reclaim tank 1406.

As shown, the irrigation system 1500 may include a disinfection apparatus 1502. The disinfection apparatus 1502 may include one or more processes to remove contaminants from the liquid that is retrieved from the reclaim tank 1406 before the liquid is moved into the supply tank 1402. Various suitable disinfection apparatuses may be used such as a disinfection apparatus provided by Priva®.

Fertilizer stock tanks 1504 may be coupled to a fertigation apparatus 1506. The fertigation apparatus 1506 may include various dosing mechanism and/or mixing mechanisms that may cause a desired quantity of fertilizer material from one or more of the fertilizer stock tanks 1504 to be combined with the liquid from the supply tank 1402. The fertigation apparatus 1506 may use a predetermined fertilizer recipe that may be beneficial to the crop growing in the grow room. The fertigation apparatus 1506 may add and/or mix the fertilizer until a desired liquid and fertilizer mixture is achieved. Various fertigation apparatuses may be used such as a fertigation apparatus provided by Priva®.

The liquid and fertilizer mixture may be moved to the grow room using suitable grow room piping 1508. The grow room piping 1508 may be coupled to one or more manifolds 1510 such an interconnection of pipes that separate the liquid and fertilizer mixture into multiple channels that can be distributed to the benches 1512. The liquid may then be drained from the benches to drain pits 1514 that may be located below the benches and/or below the grow room. Gravity may be used to move the liquid from the benches 1512 to the drain pits 1514. The liquid may then be moved from the drain pits 1514 to the reclaim tank 1406 and re-processed as previously described.

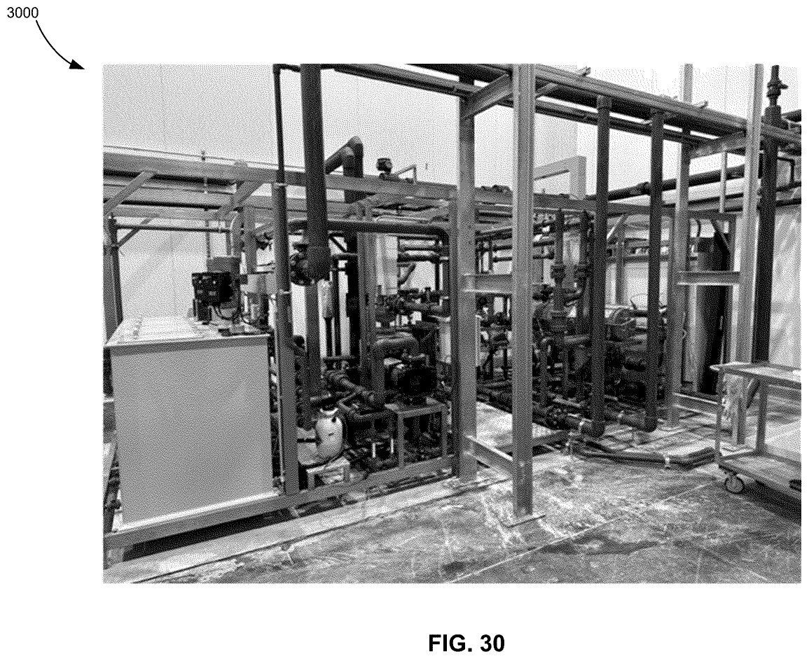

One embodiment of the irrigation system 1500 is shown in FIG. 30. The irrigation system 3000 shows one configuration of some of the elements shown in FIG. 15 and described above. In this example, the irrigation system 3000 includes the disinfection and fertigation apparatuses incorporated together with the piping, pumps, and other controls at a central or common location in the indoor farming facility.

Another example irrigation system 1600 is illustrated in FIG. 16. The irrigation system 1600 may include some elements that are similar to the irrigation system 1500 previously described. For example, the irrigation system 1600 may include a supply tank 1402 and a reclaim tank 1406. The liquid that is used in the system 1600 may also be distributed to the grow room via piping 1608 and the manifolds 1510. The liquid may be flooded to the benches 1512 and then drained into drain pits 1514 before being returned to the reclaim tank 1406.

The example irrigation system 1600 may include a EC/pH skid 1604, an irrigation skid 1606, and an incoming water source 1602. The incoming water source 1602 may be a source of water from a public source (e.g., public water supply) or natural source (e.g., spring, lake, rain water, etc.). The incoming water source 1602 may be coupled to the supply tank 1402 to ensure that the supply tank 1402 has enough volume of water to meet the needs of the crop growing in the grow room.

The EC/pH skid 1604 may be coupled to the supply tank 1402 and to the reclaim tank 1406. The EC/pH skid 1604 may include piping, pumps and electrical conductivity (EC) apparatuses and pH apparatuses. The electrical conductivity (EC) apparatus may measure and then cause the liquid in the irrigation system to be maintained at a desired electrical conductivity. Salts or other additives may be used by the EC apparatus to maintain the liquid at the desired electrical conductivity. The pH apparatus may measure and maintain the liquid at a desired pH level. The desired EC and pH levels may be determined by a crop recipe that is used for a particular crop being grow in the grow room. The EC/pH skid 1604 may cause liquid to flow from the reclaim tank 1406 to the supply tank 1402 after passing through the EC/pH skid 1604 to adjust the EC and/or the pH levels of the liquid. The EC/pH skid 1604 may also or alternatively allow water from the reclaim tank 1406 to be provided to the supply tank 1402 and bypass the disinfection apparatuses in case the disinfection apparatuses need maintenance and/or repair and water needs to be supplied to the grow room during the maintenance and/or repair.

The irrigation skid 1606 may include piping, pumps, disinfection and fertigation apparatuses integrated into a combined unit. The configuration of the irrigation skid 1606 into a combined or integrated unit may allow the irrigation skid 1606 to be constructed, tested, and/or repaired and maintained in a separate location from the growing facility. The integration of the components into the irrigation skid 1606 may allow easier installation and maintenance.

The irrigation skid 1606 may be coupled to the supply tank 1402 and to the reclaim tank 1406 in addition to the grow room piping 1608. This may allow liquid to be easily moved and nutrients added before the liquid is moved to the grow room via the piping 1608.

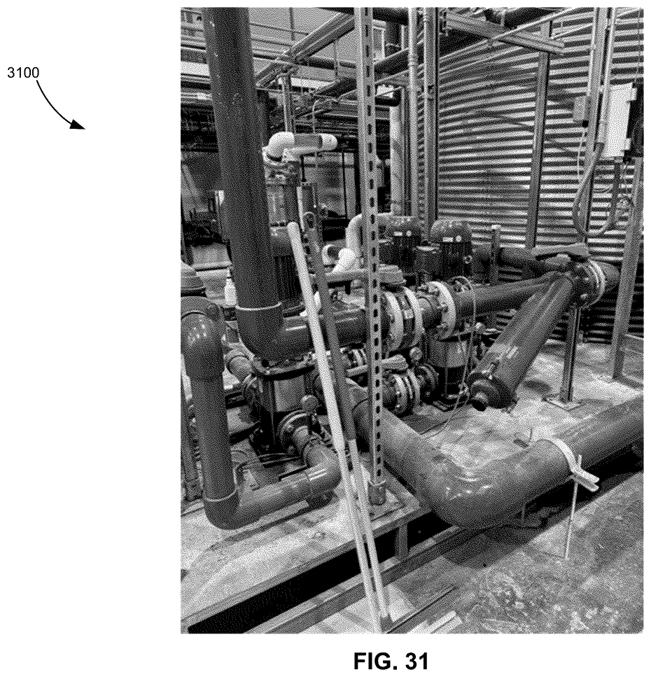

One embodiment of aspects of the irrigation system 1600 is shown in FIG. 31. The irrigation skid 3100 may include one or more pumps and piping and manifolds that are used to move water from the supply tank (the corrugated metal container shown in the FIG. 31) to the grow zone. The irrigation skid 3100 may also be coupled to the fertilization, filtration, and EC/pH systems. These systems may monitor and adjust various characteristics of the water (as described above) so that the water in the supply tank has the desired characteristics for the crop.

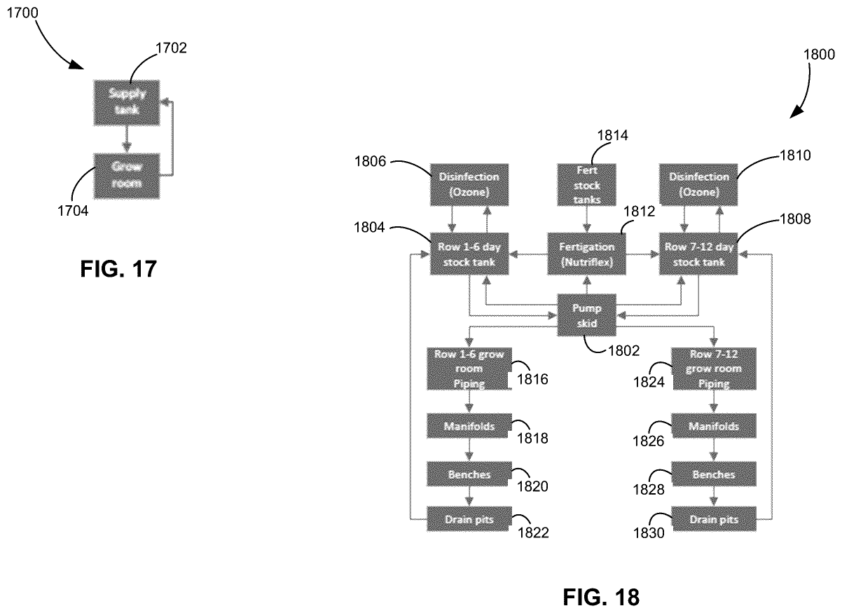

Referring now to FIGS. 17 and 18, other example irrigation systems 1700 and 1800 are illustrated. In the example irrigation system 1600, the irrigation skid 1606 may include piping, pumps, fertigation apparatuses, and disinfection apparatuses. In some instances, fertigation apparatuses and/or disinfection apparatuses may be stand-alone devices that may be purchased from one or more commercial sources. It may be desirable in such instances to remove the fertigation and/or disinfection apparatuses from the irrigation skid 1606. It may also be desirable to remove the reclaim tank 1406 from the irrigation system to simplify the system. It may also be desirable to remove the disinfection apparatus as a necessary component in the liquid flow loop because the disinfection may destroy fertilizers in the liquid mixture and require additional fertilization. Thus, the disinfection step may only be performed as needed to save resources and improve efficiency. The example irrigation system 1700 displays such a concept. The irrigation system 1700 does not include a reclaim tank like that shown in irrigation system 1400. The irrigation system 1700, in this example, only includes a supply tank 1702 coupled to the grow room 1704.

The irrigation system 1800 illustrates further aspects of an example system in which a pump skid 1802 fluidly couples the various elements of the irrigation system to each other and may lead to improved efficiencies and ease of maintenance and use. The pump skid 1802, in this example, is coupled to two portions of the grow room 1704. On the left side of FIG. 1, the first portion of the grow room may include rows 1-6 of the grow room. The pump skid 1802 may fluidly couple the irrigation system to the piping 1816, the manifolds 1818, the benches 1820, and the drain pits 1822 of the first portion of the grow room. The pump skid 1802 may also be coupled to a second portion (e.g. rows 7-12) of the grow zone. The pump skid 1802 fluidly connects the irrigation system 1800 to the second portion via the piping 1824, the manifolds 1826, the benches 1828, and the drain pits 1830. These aspects of the grow room may allow the pump skid to pump the liquid mixture to the crops by flooding the benches 1820, 1828 as previously described.

The pump skid 1802 may also be fluidly coupled to a day stock tank 1804. The day stock tank 1804 is configured to hold a volume of liquid mixture to serve the first portion of the grow room. The disinfection apparatus 1806 may be coupled to the first stock tank 1804 that serves the first portion of the grow zone. The pump skid 1802 may also be coupled to the second stock tank 1808 that serves the second portion of the grow zone. The second disinfection apparatus 1810 may be coupled to the second stock tank 1808.

The pump skid 1802 may also be coupled to the fertigation apparatus 1812. The fertilizer stock tanks 1814 may be coupled to the fertigation apparatus 1812 as previously described to provide fertilizers for mixing and/or adding to the water of other liquid mixture.

The pump skid 1802 may perform as a centralized pumping manifold to fluidly connect the various elements of the irrigation system 1800. The pump skid 1802 may be configured as an integral or combined apparatus that can be built as a unit and tested prior to being deployed and installed at a growing facility. The pump skid 1802 may include a circulation pump, fertigation filling pump, grow room supply pump, and cooling pump. The pumps may be fluidly connected through a combined suction line and various flows paths may be created using controllable valves. The pump skid 1802 may also include a heat exchanger used to cool the water or other liquid since such liquid may become heated as it flows through the grow room or other elements of the system.

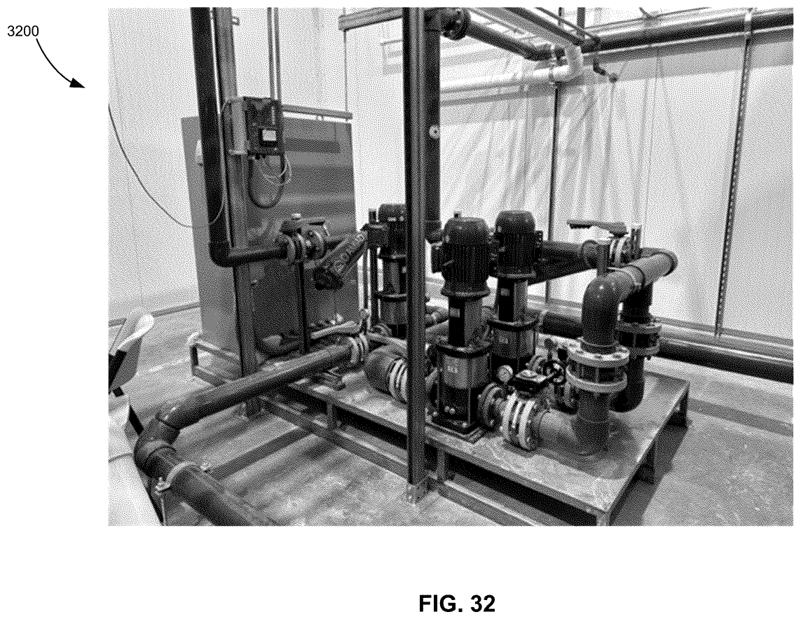

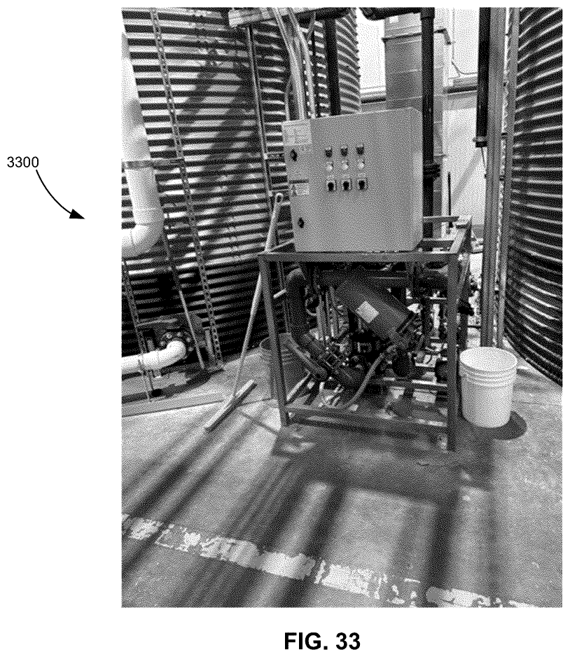

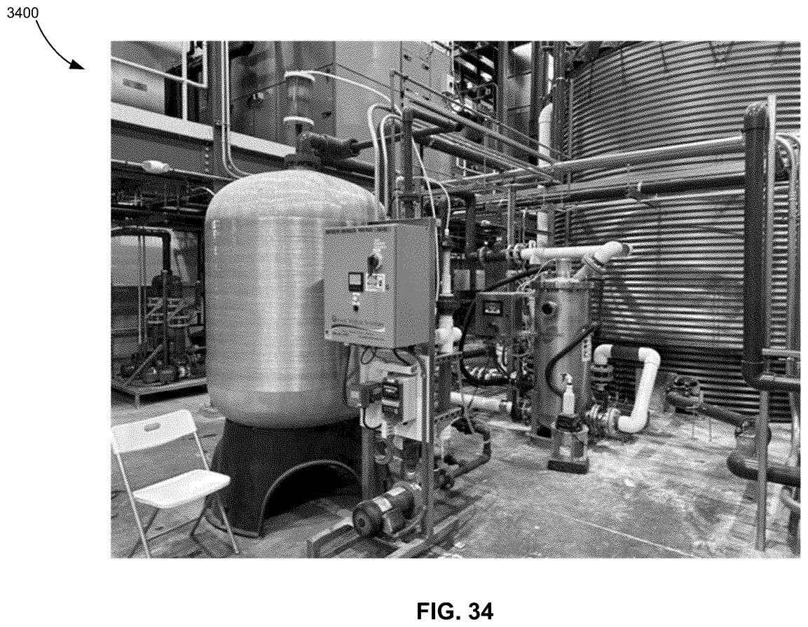

Another embodiment of an irrigation system is shown in FIGS. 32 to 34. This embodiment of the irrigation system may include a supply skid 3200, an ozone filter system 3300, and a EC/pH sensor skid 3400. This example irrigation is a variation of the irrigation system 1800 previously described. The irrigation system may have a configuration and function similar to that previously described. In this example, the irrigation system includes an ozone filter system 3300. The ozone filter system 3300 may perform functions as that described below with respect to disinfection apparatus 1806, 1810 (FIG. 18). In this example, the supply skid 3200 may move water from the supply tank to the grow zone. The water in the supply tank is monitored and processed to achieve one or more desired characteristics. The EC/pH sensor skid 3400 may take water from the supply tank to the EC/pH sensor skid 3400 to monitor and adjust electrical conductivity and pH of the water and adds nutrient based on the levels detected in order to achieve desired levels according to the crop growing in the grow zone. The ozone filter system 3300 may extract water from the supply tank and perform disinfection processes by injecting ozone into the water to remove or neutralize biological contaminants. After treatment, the water may be moved back into the supply tank from the EC/pH sensor skid 3400 and/or the ozone filter system 3000. The supply skid 3200 may then move the water directly from the supply tank to the grow zone during fertigation/irrigation of the crops in the grow zone.

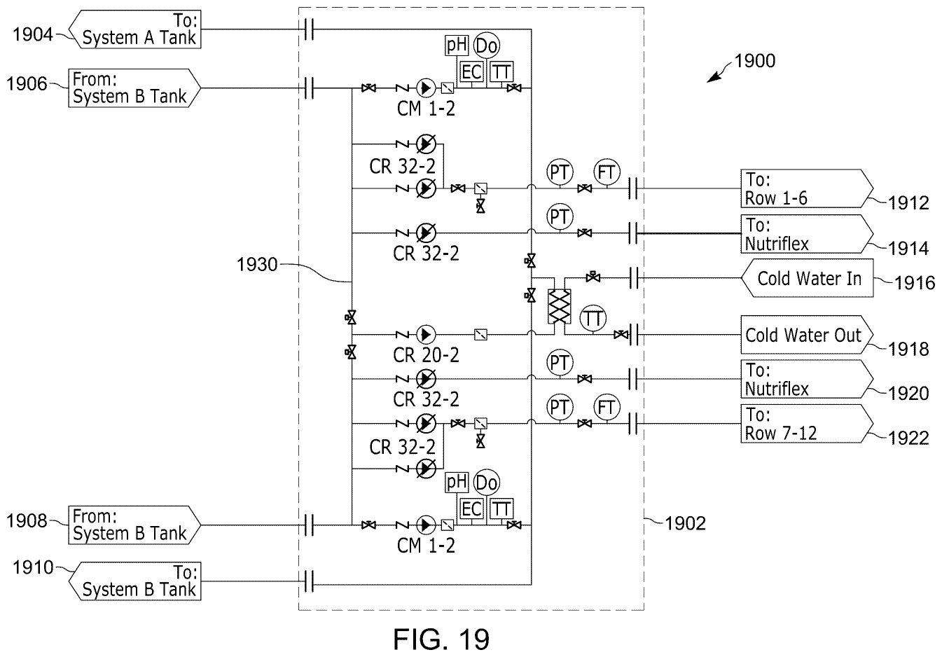

Referring now to FIGS. 19-21, another example irrigation system 1900 is illustrated. The irrigation system 1900 may include a pump skid 1902. The pump skid 1902 may be configured as previously described with respect to pump skid 1802. The suction line 1930 may connect the various pumps to the first tank and the second tank. The pump skid 1902 may be coupled to the first tank via the first inlet line 1906 and the first outlet line 1904. The pump skid 1902 may be coupled to the second tank via the second inlet line 1908 and the second outlet line 1910. The pump skid 1902 may also be coupled to the first portion of the grow zone via the first supply line 1912. The pump skid 1902 may be coupled to the second portion of the grow zone via the second supply line.

The pump skid 1902 may also be coupled to the fertigation apparatus (e.g., Nutriflex system) via the first fertigation line 1914 and the second fertigation line 1920. The pump skid 1902 may also include a cold supply 1916 and a cold return 1918 to allow cold water to flow to the heat exchanger in the pump skid 1902. The cold supply 1916 may be supplied from a chilled water generation source located at a central chiller plant. The chilled water may also be used to chill down water used for fertigation when the grow zone is a night mode of operation. The water used in fertigation may heat up when the grow zone operates in a daytime mode of operation in which the air temperature may increase and the lighting systems may be operating. The chilled water generation source may serve multiple purposes with respect to operation of the indoor farming facility, including connection to the pump skid 1902 for chilling of the water used in fertigation as well as being used to cool and/or dehumidify the airflow provided to the grow zone. This dual use may result in operating efficiencies since existing chilling capacity may be used to chill water during the night mode of operation when dehumidification needs are reduced, while still supporting chilling capacity needed for dehumidification when the grow zone may be operating in the daytime mode of operation.

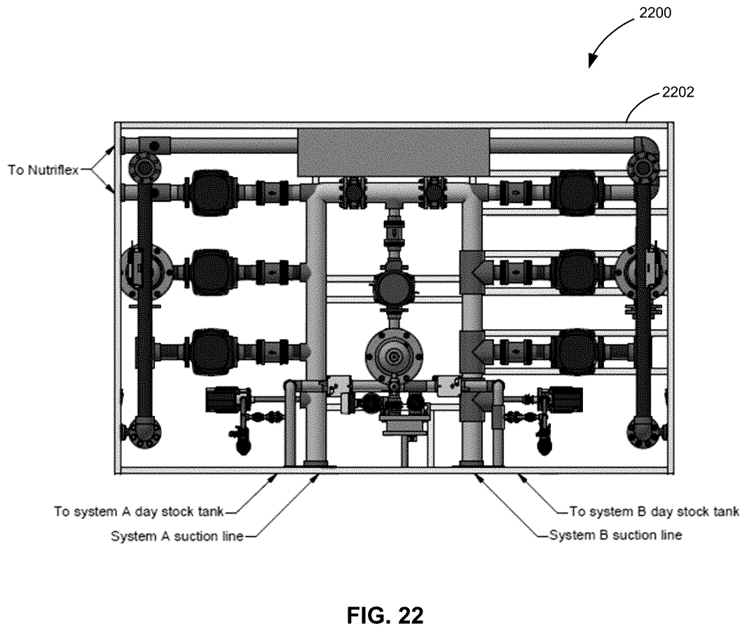

Referring now to FIGS. 22-24, an example pump skid 2200 is illustrated. The example pump skid 2200 may have the components and fluid paths as shown in FIG. 19 and discussed above. As shown, the pump skid 2200 may be an integral unit that is built on and positioned in a housing 2202, positioned on a movable platform, or other structure. The pump skid 2202 can be pre-built and pre-wired prior to installation at a service location such as the growing facility.

While not shown, the pump skid 1902 may also be operatively coupled to a controller device such as a computing device, controller, programmable logic controller (PLC), or the like to cause operations to be performed by the pump skid 1902. The controller may automatically cause the water or other liquid mixture to move through the various lines to the various elements of the irrigation system to cause a nutrient-rich water supply to be provided to the crops growing in the grow zone.

The examples described above include irrigation systems and pump skids that serve a grow room with two portions. The irrigation systems and pumps skids of the present disclosure may be configured to couple to a single grow room, or to couple to more than two portions of a grow room. The irrigation systems and pump skids may be scaled to serve various size grow rooms and growing facilities.

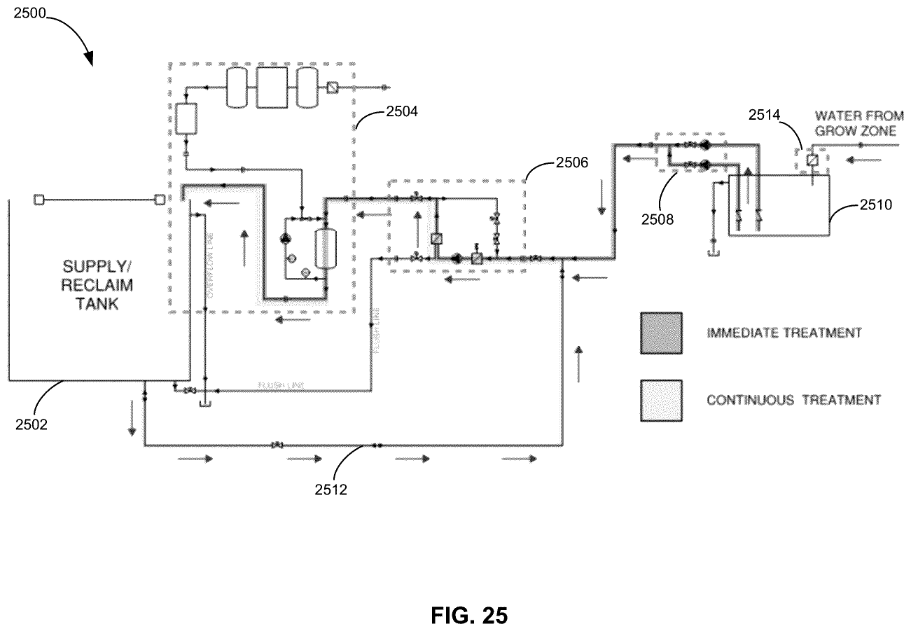

The irrigation systems of the present disclosure may also have filtration systems to provide filtration and/or treatment to the water supply to remove undesirable contaminants that may negatively impact the crop growth or may negatively impact the operation of the irrigation system. Referring now to FIG. 25, an example filtration system 2500 may include an ozone apparatus 2504, a regenerative filter apparatus 2506, and a drum filter apparatus 2514. In this example, the drum filter apparatus 2514 is coupled to an outlet that feeds water or liquid mixture from the grow zone to a drain pit 2510. The regenerative filter apparatus 2506 is positioned downstream from the drain pit 2510 and the ozone apparatus 2504 is positioned downstream of the regenerative filter apparatus 2506. The ozone apparatus 2504 may be coupled to the supply tank 2502. The filtered water may be stored in the supply tank 2502 after it has been filtered through the filtering apparatus 2500.

The drum filter apparatus 2514 may receive water from the grow zone. The water may be passed over/through a rotating filter. The rotating filter may be formed of a sieve/screen material that may allow the water to pass through but collect large particles that may be included with the water when it leaves the grow zone. The accumulated particles may block or hinder flow of water through the drum filter. The drum filter apparatus 2514 may include a sensor that determines when a predetermined level of blockage has occurred in the filter. In one example, the drum filter apparatus 2514 includes a liquid level sensor. When the blockage of the filter is at or above the predetermined blockage level, the water level in the housing in which the drum filter is located will begin to rise. When the water level reaches a predetermined level, the sensor signals that the predetermined blockage has occurred.

When the drum filter is blocked by the accumulated particles, a source of pressurized water is actuated in the drum filter apparatus. The source of pressurized water is directed at the drum filter to clean the accumulated particles from the filter. The drum filter may rotate when such cleaning is performed. The particles or other media that are removed from the drum filter are discarded via a waste line coupled to the drum filter apparatus 2514. The water filtered through the drum filter apparatus 2514 is collected in the drain pit 2510.

The water in the drain pit 2510 is moved toward the supply 2502 via a sump pump assembly 2508. The water is moved from the drain pit 2510 to the regenerative filter apparatus 2506. The regenerative filter apparatus 2506 may include high pressure low micron regenerative filter media. The regenerative filter apparatus may perform similarly to other water filters except that except instead of a standard screen, the media in the filter (e.g., Perlite) attaches to filter hoses by way of high pressure. Water may pass by this regenerative media at 1 micron, leaving behind any particulate on the media. The regenerative filter apparatus may include a flow sensor to measure a flow or pressure in the regenerative filter apparatus. Once the media has collected enough particulate to restrict flow through the filter, the flow sensor may determine that a bump process is needed. In such instances, the regenerative filter apparatus may decrease pressure and “bump” the media off the filter hoses. Pressure may then be increased, and the same media is reattached to the hoses, allowing for another filtration cycle using the same media. The regenerative filter apparatus 2506 may be periodically maintained by purging and replacing the media.

The water may then be moved through the ozone apparatus 2504. The ozone apparatus 2504 may be used to remove contaminants and other materials from the water. The ozone apparatus 2504 may be used to add ozone to the water to neutralize microbiological contaminants such as bacteria, viruses, parasites, or other materials. The ozone apparatus 2504 may include an oxygen concentrator, an ozone generator, an ozone injection skid, and a contact tank. The oxygen concentrator may obtain compressed air and generate higher purity oxygen (e.g., about 80% to 90%) to effectively generate Ozone for injection into the water. The ozone generator may use the oxygen to generate O₃ or ozone using electricity.

The ozone injection skid may be coupled to the contact tank and to the ozone generator. The ozone injection skid may obtain water from the contact via a pump. The ozone injection skid may include a sensor (e.g. an oxidation reduction potential (ORP) sensor) to determine a oxidation potential level. The measured oxidation potential level may be compared to predetermined threshold or predetermined range. The ozone injection skid may then inject ozone into the water of the contact tank until the predetermined range or threshold is reached. The water may then be moved to the supply tank 2502.

As shown, the water from the supply tank 2502 may also be recirculated through recirculation line 2512 and passed through the regenerative filter apparatus 2506 and the ozone apparatus 2504. In this manner, the volume of water in the supply tank 2502 is constantly treated to effectively treat the entire volume of water in the supply tank 2502.

The regenerative filter apparatus 2506 is in continuous operation to treat the volume of water that supplied to the grow zone unless the regenerative filter apparatus is in a bump cycle (as previously described) or the regenerative media is being replaced. In some instance, water may not flow from the grow zone into the drain pit 2510. This circumstance may occur between irrigation cycles or during a maintenance event. In such circumstances, the regenerative filter apparatus 2506 may pull water from the supply tank 2502 through the recirculation line 2512 and continue to perform the processes described above. Water may not pulled from the drain pit 2510 between irrigation cycles that occur in the grow zone. When water is not pulled from the drain pit 2510, water may be drawn through the recirculation line 2512 from the supply tank 2502. Such operation may create a “buffer” of filtered and/or ozone treated water in the supply tank 2502.

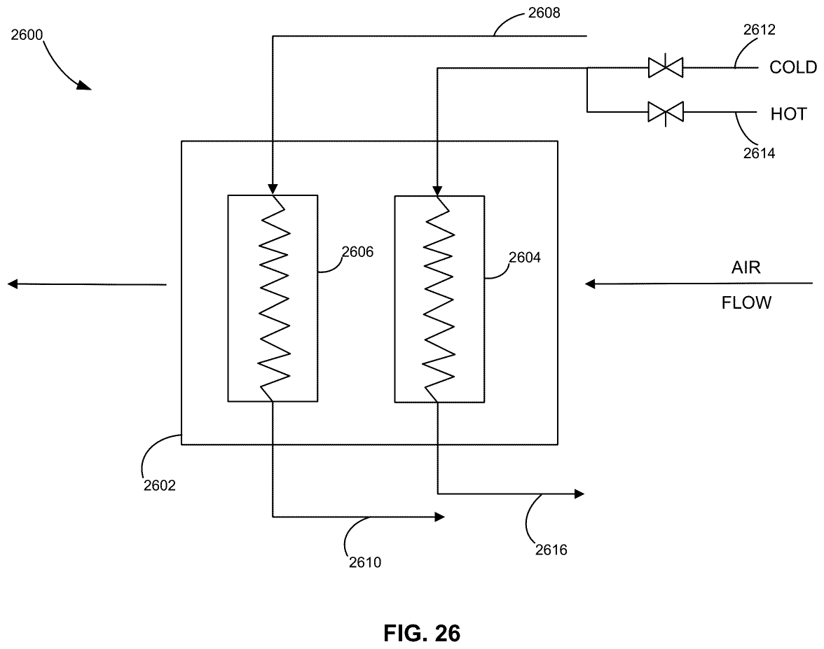

Referring now to FIG. 26, an example air conditioning apparatus 2600 is illustrated. The air flow that is provided to the grow zone may be provided having desired characteristics suitable for growth of the crops. The air flow may have a desired temperature, humidity and/or dew point. To condition the air, an air handling unit 2602 may be provided. The air handling unit 2602 may include a first heat exchanger 2604 and a second heat exchanger 2606. The air may flow through the air handling unit 2602 to pass by and/or through the first heat exchanger 2604 and through the second heat exchanger 2606. The air returning from the grow zone may be hot and humid from passing through the grow zone and over the crops. The air may need to be first cooled to remove moisture and lower the humidity. This first conditioning step may be performed by the first heat exchanger 2604. The air may then be heated to achieve a desired temperature before it is returned to the grow zone. This second conditioning step may be performed by the second heat exchanger 2606.

A refrigerant or cooling liquid, such as water, may be used in the first heat exchanger 2604 and the second heat exchanger 2606. A source of cold water may be supplied to the first heat exchanger 2604 via inlet line 2612. A source of hot water may be supplied to the second heat exchanger 2606 via the hot water inlet line 2608. The cold water may be returned via the cold return line 2616 and via the hot return line 2610. The hot water and cold water may be supplied by a refrigeration apparatus or heat pump that may heat or cool the water in the hot water or cold water loops. Such apparatuses may be located at locations distant from the air handling unit 2602. The apparatuses may located remotely from the grow zone so as to not impact the conditions of the grow zone and/or to be efficiently located to an external wall of the building so as to allow the rejection of heat to an external location, for example.

The extent to which the air flow must be cooled and then heated may vary depending on the type of crop being grown and/or the mass of the crops in the grow zone, the temperature external to the grow zone, and other factors. In some instances, it may not be needed to significantly cool the air since the air may not be significantly humid or have heated to a significant level. It may be desirable, therefore, to moderate the amount of heat that is removed from the air at the first heat exchanger 2604. In order to moderate the thermal exchange at the first heat exchanger 2604, it may be desirable to moderate the temperature of the cold water flowing into the first heat exchanger 2604. Hot water may be mixed with the cold water to moderate the temperature of the cold water flowing into the first heat exchanger 2604.

In some instances, such a mixing of the hot and cold water may occur at the heat pump or water conditioning unit that is often located remotely from the air handling unit 2602. Such mixing may be suffer from inefficiencies as it travels to the air handler. Furthermore, the hot and cold water sources may be coupled to multiple air handlers. The temperature of the cold water cannot be moderated or controlled individually for each air handler 2602 in these instances. The mixing is accomplished centrally by the centralized hot and cold water sources. Thus, inefficiencies may result and individualized cold water moderation is difficult to achieve.

In the example provided, the mixing or moderation of the cold water at the first heat exchanger 2604 may be accomplished locally at each individual air handler 2602. As shown, a first valve 2612 and a second valve 2614 may be provided locally to the air handler 2602. Such valves may be locate within a range of 0.5 to 6 feet from the air handler 2602. In this manner, the customized moderation of the cold water at the cold water input to the first heat exchanger 2604 may be accomplished. The first valve and the second valve may be automatically controlled by a controller or computing device to achieve the moderation of the cold water at the first heat exchanger 2604. In some embodiments, the grow zone may be provided with conditioned air from an array of air handling apparatuses 2600. Each may have the configuration described above.

The configuration or concepts described above and shown in FIG. 26 may be replicated at each air handler that maybe used to condition air for a grow zone. In some instances, an array of air handling units 2602 may be used to provide and condition air for the grow zone. The cold water moderating apparatus previously described may be provided for individualized control at each air handling unit 2602.

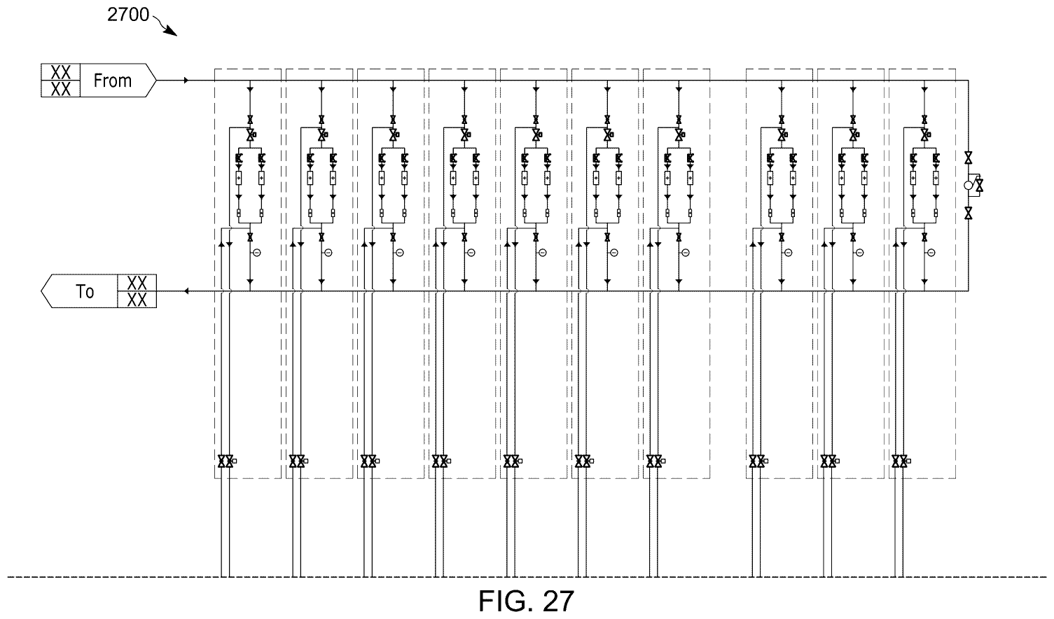

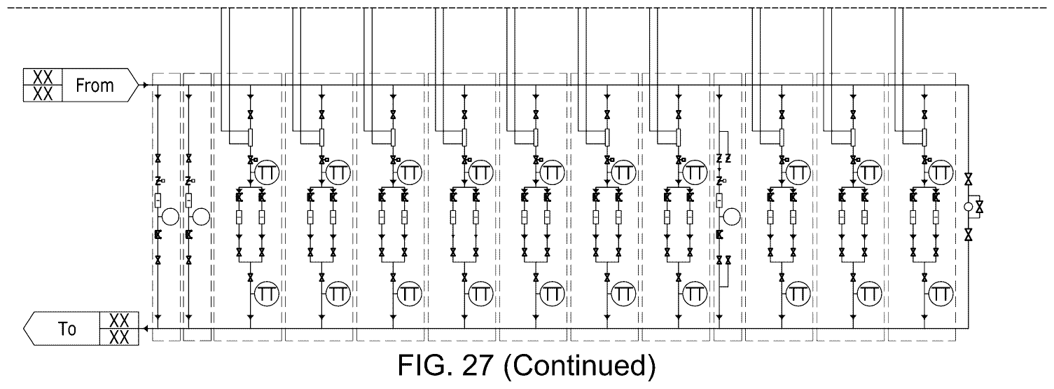

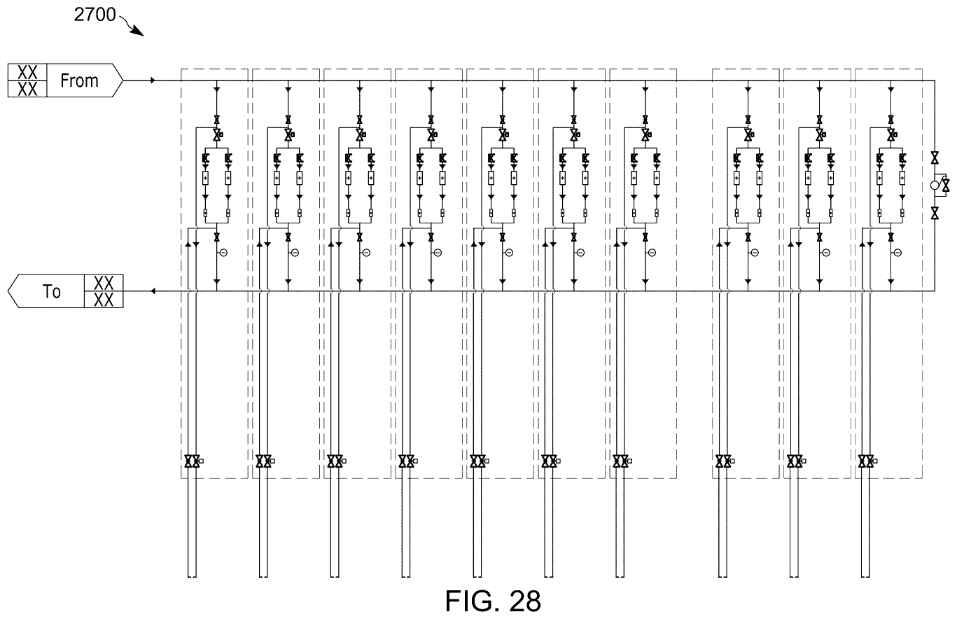

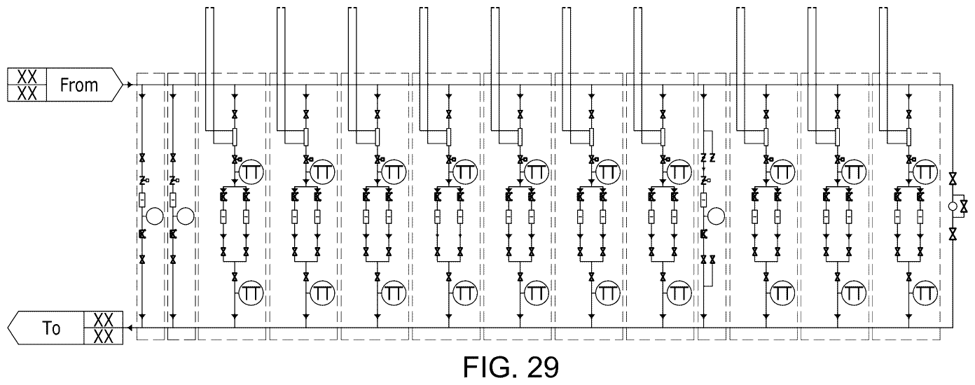

Referring now to FIGS. 27 to 29, an example fluid control system 2700 is shown. The fluid control system 2700 illustrates an example piping layout that may be used to provide hot water and cold water to an air condition apparatus, such as air conditioning apparatus 2600 previously described. The fluid control 2700 may include the water mixing features that allow for local moderation of a cold water supply at or near a first heat exchanger of an air handling apparatus.

The example methods and apparatuses described herein may be at least partially embodied in the form of computer-implemented processes and apparatus for practicing those processes and/or the described functionality. The disclosed methods may also be at least partially embodied in the form of tangible, non-transient machine readable storage media encoded with computer program code. The media may include, for example, RAMs, ROMs, CD-ROMs, DVD-ROMs, BD-ROMs, hard disk drives, flash memories, or any other non-transient machine-readable storage medium, or any combination of these mediums, wherein, when the computer program code is loaded into and executed by a computer, the computer becomes an apparatus for practicing the method. The methods may also be at least partially embodied in the form of a computer into which computer program code is loaded and/or executed, such that, the computer becomes an apparatus for practicing the methods. When implemented on a general-purpose processor, the computer program code segments configure the processor to create specific logic circuits. The methods may alternatively be at least partially embodied in a digital signal processor formed of application specific integrated circuits for performing the methods.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

The following lists non-limiting embodiments of the present disclosure.

Illustrative embodiment 1: An air handling system for providing an air flow to an indoor grow zone comprising: a plenum wall positioned at a first side of the grow zone; a return wall positioned at a second side of the grow zone opposite to the first side; and a return duct positioned at a top of the return wall to return the air flow from the return wall to the first side of the grow zone.

Illustrative embodiment 2. The air handling system of illustrative embodiment 1, wherein the plenum wall and the return wall are oriented vertically and the return duct is oriented horizontally.

Illustrative embodiment 3. The air handling system of any of illustrative embodiments 1 or 2, wherein the plenum wall comprises an outside wall and an inside wall defining an internal cavity, and the outside wall comprises one opening to supply the air flow to the internal cavity.

Illustrative embodiment 4. The air handling system of illustrative embodiment 3, comprising a diverter connected to the outside wall, the diverter formed of a perforated diffuser plate.

Illustrative embodiment 5. The air handling system of illustrative embodiment 4, wherein the perforated diffuser plate is positioned substantially parallel to and separated from the opening in the outside wall.

Illustrative embodiment 6. The air handling system of any of illustrative embodiments 4 or 5, wherein the perforated diffuser plate is connected to the outside wall by a plurality of supports extending from an inner surface of the outside wall.

Illustrative embodiment 7. The air handling system of any of illustrative embodiments 3 to 6, wherein the inner wall is formed from an array of distributors.

Illustrative embodiment 8. The air handling system of illustrative embodiment 7, wherein each distributor of the array of distributors comprises a rectangular box.

Illustrative embodiment 9. The air handling system of any of illustrative embodiments 7 or 8, wherein each distributor comprises an aperture in the upstream side of the rectangular box and a projection positioned at a center of the aperture to guide air flow toward each of the corners of the interior of the rectangular box.

Illustrative embodiment 10. The air handling system of any of illustrative embodiments 1 to 9, wherein an inner side of the return wall is formed from an array of intake boxes.

Illustrative embodiment 11. The air handling system of illustrative embodiment 10, wherein each intake box comprises an intake side facing the grow zone and an opposite side spaced apart from and opposite to the intake side.

Illustrative embodiment 12. The air handling system of illustrative embodiment 11, wherein the intake side is formed from a panel of perforated material.

Illustrative embodiment 13. The air handling system of any of illustrative embodiments 10 to 12, wherein the opposite side of each intake box of the array of intake boxes comprises at least one intake opening.

Illustrative embodiment 14. The air handling system of illustrative embodiment 13, wherein an area of the at least one intake opening of an intake box positioned at a top of the array of intake boxes differs from an area of the at least one intake opening in an intake box positioned under the top of the array of intake boxes.

Illustrative embodiment 15. The air handling system of illustrative embodiment 14, wherein the area of the at least one intake opening of an intake box positioned at the top of the array of intake boxes is less than an area of the at least one intake opening in an intake box positioned under the top of the array of intake boxes.

Illustrative embodiment 16. The air handling system of any of illustrative embodiments 10 to 15, wherein a laminar flow is maintained in the grow zone by varying a suction at the return wall at different vertical positions.

Illustrative embodiment 17. The air handling system of illustrative embodiment 16, wherein the suction is varied by varying an area of openings in an intake side of the array of intake boxes.

Illustrative embodiment 18. The air handling system of any of illustrative embodiments 10 to 17, wherein an outer side of the return wall is separated from the array of intake boxes to define an interior space to guide the air flow to the return duct.

Illustrative embodiment 19. The air handling system of any of illustrative embodiments 1 to 18, wherein a flow guide couples the return wall to the return duct and comprises a plurality of curved vanes to guide the air flow from a vertical flow to a horizontal flow.

Illustrative embodiment 20. The air handling system of any of illustrative embodiments 1 to 19, further comprising an air handling unit coupled between the return duct and the plenum wall.

Illustrative embodiment 21. An irrigation system for an indoor grow zone comprising: a first stock tank configured to provide a first water supply to a first portion of the grow zone; a second stock tank configured to provide a second water supply to a second portion of the grow zone; a fertigation apparatus configured to provide fertilizers to the first water supply and the second water supply; and a pump skid fluidly coupled to the first stock tank, the second stock tank, the fertigation apparatus, and the grow zone, the pump skid configured as an integral unit with a plurality of pumps to move the first water supply and the second water supply through the fertigation apparatus and to the first portion of the grow zone and the second portion of the grow zone, respectively.

Illustrative embodiment 22. The irrigation system of illustrative embodiment 21, wherein the pump skid comprises a housing on which the plurality of pumps are positioned.

Illustrative embodiment 23. The irrigation system of any of illustrative embodiments 21 or 22, wherein the pump skid comprises a heat exchanger coupled to a cooling fluid to cool the first water supply and the second water supply.

Illustrative embodiment 24. The irrigation system of any of illustrative embodiments 21 to 23, further comprising a first disinfection apparatus coupled to the first stock tank and a second disinfection apparatus coupled to the second stock tank.

Illustrative embodiment 25. The irrigation system of illustrative embodiment 24, wherein the first stock tank is coupled to the first disinfection apparatus by a disinfection loop that is separate from a first fertigation loop that couples the first stock tank to the fertigation apparatus.

Illustrative embodiment 26. The irrigation system of any of illustrative embodiments 21 to 25, wherein the fertigation apparatus comprises one or more tanks of fertilizer materials and one or more sensors to determine one or more characteristics of the first water supply and the second water supply.

Illustrative embodiment 27. A filtration system for use with an indoor grow zone comprising: a drain receptacle configured to collect water from the grow zone; a supply tank configured to hold a volume of water for supply to the grow zone; a plurality of filter apparatuses fluidly coupled between the drain receptacle and the supply tank; and a recirculation line fluidly coupled to the supply tank and the drain receptacle; wherein water circulates through the recirculation line from the supply tank through the plurality of filter apparatuses when water is not available from the drain receptacle.

Illustrative embodiment 28. The filtration system of illustrative embodiment 27, wherein the plurality of filter apparatuses comprises a regenerative filter apparatus and an ozone apparatus.

Illustrative embodiment 29. The filtration system of any of illustrative embodiments 27 or 28, wherein the regenerative filter apparatus comprises a filter media and a flow sensor, the flow sensor configured to cause a decrease in pressure at the filter media when a flow falls below a flow threshold.

Illustrative embodiment 30. The filtration system of any of illustrative embodiments 28 or 29, wherein the ozone apparatus comprises an oxygen concentrator and an ozone generator.

Illustrative embodiment 31. The filtration system of any of illustrative embodiments 27 to 30, wherein the drain receptacle comprises a drain pit configured to retain water from the grow zone after an irrigation cycle is performed.

Illustrative embodiment 32. The filtration system of any of illustrative embodiments 27 to 31, further comprising a drum filter apparatus fluidly connected between the drain receptacle and the plurality of filter apparatuses.

Illustrative embodiment 33. The filtration system of illustrative embodiment 32, wherein the drum filter comprises a rotating filter and a liquid level sensor, the liquid level sensor is configured to cause a source of pressurized water to clean accumulated particles from the filter when a liquid level in the drum filter is at or above a predetermined blockage level.

Illustrative embodiment 34. The filtration system of any of illustrative embodiments 27 to 33, wherein the system is operable in a first mode of operation in which water flows from the drain receptacle through the plurality of filter apparatuses and into the supply tank, and in a second mode of operation in which water recirculates through the recirculation line from the supply tank through the plurality of filter apparatuses, the system maintaining a sufficient volume of filtered water for supply to the grow zone when water is not available from the drain receptacle.

Illustrative embodiment 35. An air conditioning apparatus for providing an air flow to an indoor grow zone comprising: an air handling unit for moving the air flow; a first heat exchanger configured to lower a temperature of the airflow and to lower a humidity of the air flow; and a second heat exchanger positioned downstream of the first heat exchanger and configured to raise the temperature of the air flow before the air flow is provided to the indoor grow zone.

Illustrative embodiment 36. The air conditioning apparatus of illustrative embodiment 35, further comprising a cold water inlet line coupled to the first heat exchanger.

Illustrative embodiment 37. The air conditioning apparatus of illustrative embodiments 35 or 36, further comprising a first hot water inlet line coupled to the second exchanger.

Illustrative embodiment 38. The air conditioning apparatus of illustrative embodiment 37, further comprising a second hot water inlet line coupled to the cold water inlet line.

Illustrative embodiment 39. The air conditioning apparatus of illustrative embodiment 38, further comprising a first valve located in the second hot water inlet line and a second valve located in the cold water inlet line, wherein the first valve and the second valve may be controlled to permit moderation of the temperature of the water provided to the first heat exchanger.

Illustrative embodiment 40. The air conditioning apparatus of illustrative embodiment 39, wherein the first valve and the second valve are located locally to the air handling unit.

Illustrative embodiment 41. The air conditioning apparatus of any of illustrative embodiments 39 or 40, wherein the first valve and the second valve are located at a distance of about 0.5 feet to about 6 feet from the air handling unit.

What is claimed is:

1. An air handling system for providing an air flow to an indoor grow zone comprising:
a plenum wall positioned at a first side of the grow zone;
a return wall positioned at a second side of the grow zone opposite to the first side; and
a return duct positioned at a top of the return wall to return the air flow from the return wall to the first side of the grow zone.

2. The air handling system of claim 1, wherein the plenum wall and the return wall are oriented vertically and the return duct is oriented horizontally.

3. The air handling system of claim 1, wherein the plenum wall comprises an outside wall and an inside wall defining an internal cavity, and the outside wall comprises one opening to supply the air flow to the internal cavity.

4. The air handling system of claim 3, comprising a diverter connected to the outside wall, the diverter formed of a perforated diffuser plate.

5. The air handling system of claim 4, wherein the perforated diffuser plate is positioned substantially parallel to and separated from the opening in the outside wall.

6. The air handling system of claim 5, wherein the perforated diffuser plate is connected to the outside wall by a plurality of supports extending from an inner surface of the outside wall.

7. The air handling system of claim 3, wherein the inner wall is formed from an array of distributors.

8. The air handling system of claim 7, wherein each distributor of the array of distributors comprises a rectangular box.

9. The air handling system of claim 8, wherein each distributor comprises an aperture in the upstream side of the rectangular box and a projection positioned at a center of the aperture to guide air flow toward each of the corners of the interior of the rectangular box.

10. The air handling system of claim 1, wherein an inner side of the return wall is formed from an array of intake boxes.

11. The air handling system of claim 10, wherein each intake box comprises an intake side facing the grow zone and an opposite side spaced apart from and opposite to the intake side.

12. The air handling system of claim 11, wherein the intake side is formed from a panel of perforated material.

13. The air handling system of claim 12, wherein the opposite side of each intake box of the array of intake boxes comprises at least one intake opening.

14. The air handling system of claim 13, wherein an area of the at least one intake opening of an intake box positioned at a top of the array of intake boxes differs from an area of the at least one intake opening in an intake box positioned under the top of the array of intake boxes.

15. The air handling system of claim 14, wherein the area of the at least one intake opening of an intake box positioned at the top of the array of intake boxes is less than an area of the at least one intake opening in an intake box positioned under the top of the array of intake boxes.

16. The air handling system of claim 10, wherein a laminar flow is maintained in the grow zone by varying a suction at the return wall at different vertical positions.

17. The air handling system of claim 16, wherein the suction is varied by varying an area of openings in an intake side of the array of intake boxes.

18. The air handling system of claim 10, wherein an outer side of the return wall is separated from the array of intake boxes to define an interior space to guide the air flow to the return duct.

19. The air handling system of claim 18, wherein a flow guide couples the return wall to the return duct and comprises a plurality of curved vanes to guide the air flow from a vertical flow to a horizontal flow.

20. The air handling system of claim 1, further comprising an air handling unit coupled between the return duct and the plenum wall.

21. An irrigation system for an indoor grow zone comprising:
a first stock tank configured to provide a first water supply to a first portion of the grow zone;
a second stock tank configured to provide a second water supply to a second portion of the grow zone;
a fertigation apparatus configured to provide fertilizers to the first water supply and the second water supply; and
a pump skid fluidly coupled to the first stock tank, the second stock tank, the fertigation apparatus, and the grow zone, the pump skid configured as an integral unit with a plurality of pumps to move the first water supply and the second water supply through the fertigation apparatus and to the first portion of the grow zone and the second portion of the grow zone, respectively.

22. The irrigation system of claim 21, wherein the pump skid comprises a housing on which the plurality of pumps are positioned.

23. The irrigation system of claim 21, wherein the pump skid comprises a heat exchanger coupled to a cooling fluid to cool the first water supply and the second water supply.

24. The irrigation system of claim 21, further comprising a first disinfection apparatus coupled to the first stock tank and a second disinfection apparatus coupled to the second stock tank.

25. The irrigation system of claim 24, wherein the first stock tank is coupled to the first disinfection apparatus by a disinfection loop that is separate from a first fertigation loop that couples the first stock tank to the fertigation apparatus.

26. The irrigation system of claim 21, wherein the fertigation apparatus comprises one or more tanks of fertilizer materials and one or more sensors to determine one or more characteristics of the first water supply and the second water supply.

27. A filtration system for use with an indoor grow zone comprising:
a drain receptacle configured to collect water from the grow zone;
a supply tank configured to hold a volume of water for supply to the grow zone;
a plurality of filter apparatuses fluidly coupled between the drain receptacle and the supply tank; and
a recirculation line fluidly coupled to the supply tank and the drain receptacle;
wherein water circulates through the recirculation line from the supply tank through the plurality of filter apparatuses when water is not available from the drain receptacle.

28. The filtration system of claim 27, wherein the plurality of filter apparatuses comprises a regenerative filter apparatus and an ozone apparatus.

29. The filtration system of claim 27, wherein the regenerative filter apparatus comprises a filter media and a flow sensor, the flow sensor configured to cause a decrease in pressure at the filter media when a flow falls below a flow threshold.

30. The filtration system of claim 28, wherein the ozone apparatus comprises an oxygen concentrator and an ozone generator.

31. The filtration system of claim 27, wherein the drain receptacle comprises a drain pit configured to retain water from the grow zone after an irrigation cycle is performed.

32. The filtration system of claim 27, further comprising a drum filter apparatus fluidly connected between the drain receptacle and the plurality of filter apparatuses.

33. The filtration system of claim 32, wherein the drum filter comprises a rotating filter and a liquid level sensor, the liquid level sensor is configured to cause a source of pressurized water to clean accumulated particles from the filter when a liquid level in the drum filter is at or above a predetermined blockage level.

34. The filtration system of claim 27, wherein the system is operable in a first mode of operation in which water flows from the drain receptacle through the plurality of filter apparatuses and into the supply tank, and in a second mode of operation in which water recirculates through the recirculation line from the supply tank through the plurality of filter apparatuses, the system maintaining a sufficient volume of filtered water for supply to the grow zone when water is not available from the drain receptacle.

35. An air conditioning apparatus for providing an air flow to an indoor grow zone comprising:
an air handling unit for moving the air flow;
a first heat exchanger configured to lower a temperature of the airflow and to lower a humidity of the air flow; and
a second heat exchanger positioned downstream of the first heat exchanger and configured to raise the temperature of the air flow before the air flow is provided to the indoor grow zone.

36. The air conditioning apparatus of claim 35, further comprising a cold water inlet line coupled to the first heat exchanger.

37. The air conditioning apparatus of claim 36, further comprising a first hot water inlet line coupled to the second exchanger.

38. The air conditioning apparatus of claim 37, further comprising a second hot water inlet line coupled to the cold water inlet line.

39. The air conditioning apparatus of claim 38, further comprising a first valve located in the second hot water inlet line and a second valve located in the cold water inlet line, wherein the first valve and the second valve may be controlled to permit moderation of the temperature of the water provided to the first heat exchanger.

40. The air conditioning apparatus of claim 39, wherein the first valve and the second valve are located locally to the air handling unit.

41. The air conditioning apparatus of claim 39, wherein the first valve and the second valve are located at a distance of about 0.5 feet to about 6 feet from the air handling unit.
